(19) United States
(12) Patent Application Publication
(10) Pub. No.: US 2024/0375641 A1
(43) Pub. Date: Nov. 14, 2024

(54) CONTROL DEVICE FOR VEHICLE, CONTROL METHOD FOR VEHICLE, AND NONTRANSITORY COMPUTER RECORDING MEDIUM

(71) Applicants: Toyota Jidosha Kabushiki Kaisha, Toyota-shi (JP); Denso Corporation, Kariya-city (JP)

(72) Inventors: Kenichiroh Hara, Yokohama-shi (JP); Jiro Fujino, Toyota-shi (JP); Satoru Kawakami, Tokyo-to (JP); Hiroshi Morimoto, Tokyo-to (JP); Kenta Yamada, Tokyo-to (JP)

(73) Assignees: Toyota Jidosha Kabushiki Kaisha, Toyota-shi (JP); Denso Corporation, Kariya-city (JP)

(21) Appl. No.: 18/623,330

(22) Filed: Apr. 1, 2024

(30) Foreign Application Priority Data
May 9, 2023 (JP) 2023-077377

(51) Int. Cl. B60W 30/09; B60W 50/14

(52) U.S. Cl. CPC B60W 30/09; B60W 50/14; B60W 2520/10; B60W 2540/225; B60W 2552/05

(57) ABSTRACT

A control device is configured to: detect an object present around a vehicle to which attention should be paid based on surrounding data showing a situation around the vehicle; detect a gaze origin and gaze direction of the driver based on driver data showing a state of a driver of the vehicle; set a field of vision of the driver toward the gaze direction of the driver based on a speed of the vehicle, a type of road, or a shape of road, set a virtual plane on which the object is projected at the position of the object so as to face the vehicle and judge whether a field of vision of the driver overlaps the projected location of the object; and initiate a safety measure if the field of vision of the driver does not overlap the projected location of the object.

### FIELD

The present invention relates to a control device for a vehicle, a control method for a vehicle, and a nontransitory computer recording medium.

### BACKGROUND

Japanese Unexamined Patent Publication No. 2019-185218 discloses a conventional warning device able to provide an alert in accordance with a state of attention of a driver. This is configured to calculate a point which the driver is paying attention to based on gaze information showing a direction of gaze of the driver and eyeball position information showing a position of an eyeball of the driver in a three-dimensional coordinate system, judge whether the driver is paying attention to an object based on the object to be paid attention to and the point of attention, and alert the driver when it is judged the driver is not paying attention to it.

### SUMMARY

A field of vision of a driver tends to become narrower the higher a speed of a vehicle. For this reason, it tends to become difficult for a driver to recognize another vehicle, a pedestrian, or another object at the outside the higher the speed of the vehicle. Therefore, if not judging whether a driver is able to recognize an object outside of the vehicle considering also such changes in the range of the field of vision, it is liable to end up being judged that an object to be paid attention to outside of the vehicle has been recognized by the driver regardless of the object not having been recognized by the driver.

The present invention was made focusing on such a problem and has as its object to enable it to be judged whether a driver recognizes an object outside of a vehicle considering changes in the range of the field of vision of the driver.

The gist of the present disclosure is as follows:
(1) A control device for a vehicle, wherein the control device is configured to: detect an object present around the vehicle to which attention should be paid based on surrounding data showing a situation around the vehicle; detect a gaze direction of the driver based on driver data showing a state of a driver of the vehicle; set a field of vision of the driver toward the gaze direction of the driver based on a speed of the vehicle, a type of road, or a shape of road; set a virtual plane on which the object is projected at the position of the object so as to face the vehicle and judge whether a field of vision of the driver overlaps the projected location of the object; and initiate a safety measure if the field of vision of the driver does not overlap the projected location of the object.
(2) The control device for a vehicle according to the above (1), wherein the control device is further configured to set as the field of vision of the driver a cone having a gaze origin of the driver as an apex, having a gaze vector extending from the gaze origin of the driver toward the gaze direction of the driver as a center axis, and having a predetermined apex angle and to change the apex angle based on the speed of the vehicle, type of road, or shape of road.
(3) The control device for a vehicle according to the above (2), wherein the control device is further configured to set the apex angle to a smaller value when the speed of the vehicle is high compared to when it is low.
(4) The control device for a vehicle according to the above (2), wherein the control device is further configured to set the apex angle to a smaller value when the type of the road is a road with a high average speed compared to when the type of the road is a road with a low average speed.
(5) The control device for a vehicle according to the above (2), wherein the control device is further configured to set the apex angle to a smaller value when the shape of the road is a shape enabling running by a relatively high speed compared to when the shape of the road is a shape where it is necessary to run at a relatively low speed.
(6) The control device for a vehicle according to any one of the above (1) to the above (5), wherein the vehicle includes an output device configured to provide notification to the driver, and the control device is configured to provide notification through the output device as the safety measure.
(7) The control device for a vehicle according to any one of the above (1) to the above (6), wherein the control device is further configured to perform, as the safety measure, driving operations of the vehicle automatically so as to avoid an object.
(8) A control method for a vehicle by a control device, wherein the control method comprises: detecting an object present around the vehicle to which attention should be paid based on surrounding data showing a situation around the vehicle; detecting a gaze direction of the driver based on driver data showing a state of a driver of the vehicle; setting a field of vision of the driver toward the gaze direction of the driver based on a speed of the vehicle, a type of road, or a shape of road; setting a virtual plane on which the object is projected at the position of the object so as to face the vehicle and judging whether a field of vision of the driver overlaps the projected location of the object; and initiating a safety measure if the field of vision of the driver does not overlap the projected location of the object.
(9) A nontransitory computer recording medium including a computer program for a control device for a vehicle, the nontransitory computer recording medium including a computer program making the control device: detect an object present around the vehicle to which attention should be paid based on surrounding data showing a situation around the vehicle; detect a gaze direction of the driver based on driver data showing a state of a driver of the vehicle; set a field of vision of the driver toward the gaze direction of the driver based on a speed of the vehicle, a type of road, or a shape of road; set a virtual plane on which the object is projected at the position of the object so as to face the vehicle and judge whether a field of vision of the driver overlaps the projected location of the object; and initiate a safety measure if the field of vision of the driver does not overlap the projected location of the object.

The present invention was made focusing on such a problem and has as its object to make it possible to set a field of vision of a driver to a suitable range corresponding to a speed of a vehicle, a type of road, or a shape of road so as to enable it to be judged whether a driver recognizes an object outside of the vehicle considering changes in the range of the field of vision of the driver.

### BRIEF DESCRIPTION OF DRAWINGS

FIG. 1 is a schematic view of a system configuration of a vehicle according to one embodiment of the present invention.

FIG. 2 is a view showing a hardware configuration of a control device.

FIG. 3 is a flow chart for explaining details of processing for notification according to one embodiment of the present invention.

FIG. 4 is a view for explaining a field of vision of a driver.

FIG. 5 is a view for explaining one example of a vision field setting line graph for setting an apex angle of a viewing cone based on a speed of a vehicle.

FIG. 6A is a view for explaining one example of a method for judging whether a driver could recognize an object requiring attention.

FIG. 6B is a view for explaining one example of a method for judging whether a driver could recognize an object requiring attention.

### DESCRIPTION OF EMBODIMENTS

Below, embodiments of the present invention will be explained in detail with reference to the drawings. Note that in the following explanation, similar component elements will be assigned the same reference notations.

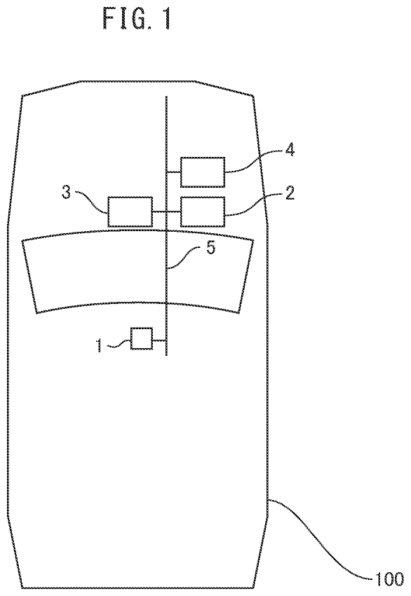

FIG. 1 is a schematic view of a system configuration of a vehicle 100 according to one embodiment of the present invention.

The vehicle 100 is provided with a surrounding sensor 1, driver sensor 2, output device 3, and control device 4. The surrounding sensor 1, driver sensor 2, output device 3, and control device 4 are connected to be able to communicate through an internal vehicle network 5 based on the Controller Area Network standard. The vehicle 100 may be a vehicle equipped with an automated driving function or driver's assistance function or may be a manually driven vehicle.

The surrounding sensor 1 is a sensor for generating surrounding data showing the situation around the vehicle 100. In the present embodiment, as the surrounding sensor 1, one or more external cameras for capturing the surroundings of the vehicle 100 are provided. An external camera captures the surroundings of the vehicle 10 by a predetermined frame rate (for example, 10 Hz to 40 Hz) and generates surrounding images in which the surroundings of the vehicle 100 are reflected. The external camera sends the generated surrounding images as surrounding data to the control device 4 each time generating surrounding images.

Note that instead of an external camera or in addition to an external camera, it is also possible to provide as a surrounding sensor 1 a distance measurement sensor for measuring the distance up to another vehicle or pedestrian, bicycle, or other object present around the vehicle 100. As an example of a distance measurement sensor, for example, a lidar (light detection and ranging device) for emitting laser light and measuring distance based on its reflected light, a millimeter wave radar sensor for emitting an electromagnetic wave and measuring distance based on its reflected wave, etc. may be mentioned.

The driver sensor 2 is a sensor for generating driver data showing the state of a driver. In the present embodiment, as the driver sensor 2, a driver monitor camera is provided for capturing the appearance of the driver, including the face of the driver. The driver monitor camera captures the appearance of the driver by a predetermined frame rate (for example, 10 Hz to 40 Hz) and generates external images in which the appearance of the driver is reflected. The driver monitor camera sends the generated external images as driver data to the control device 4 each time generating external images of the driver.

The output device 3 is a device for notifying information to a driver through physical senses of the driver of the vehicle 100 (for example, sight, hearing, touch, etc.) In the present embodiment, as the output device 3, a display arranged at a position which the driver can view (for example, instrumentation display, center display, heads up display, etc.) and a speaker are provided. The display displays information corresponding to a display signal output from the control device 4 (for example, text information or image information). The speaker outputs audio corresponding to an audio signal output from the control device 4.

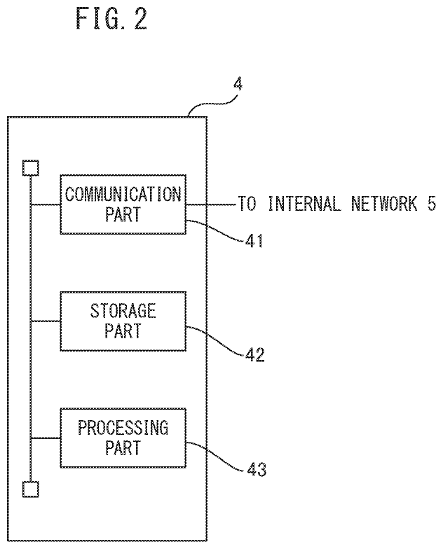

The control device 4 is an ECU (electronic control unit) provided with a communication part 41, storage part 42, and processing part 43 (see FIG. 2) and is configured to at least be able to identify an object outside of the vehicle to which attention should be paid (object requiring attention) and notifying the driver through the output device 3 in accordance with the state of recognition of the object by the driver. The control device 4 can receive, as input, in addition to the above-mentioned surrounding data and driver data, for example, vehicle position data acquired by a position measuring sensor, vehicle speed data acquired by a vehicle speed sensor, or other various types of data.

FIG. 2 is a view showing the hardware configuration of the control device 4.

The control device 4 is provided with a communication part 41, storage part 42, and processing part 43.

The communication part 41 is provided with an interface circuit for connecting the control device 4 to an internal vehicle network 5. The communication part 41 supplies the data received from the outside (surrounding data, driver data, etc.) to the processing part 43. Further, the communication part 41 sends the display signal and audio signal output from the processing part 43 to the output device 3.

The storage part 42 has a HDD (hard disk drive) or SSD (solid state drive) or semiconductor memory or other storage medium and stores various computer programs and data etc. used for processing at the processing part 43.

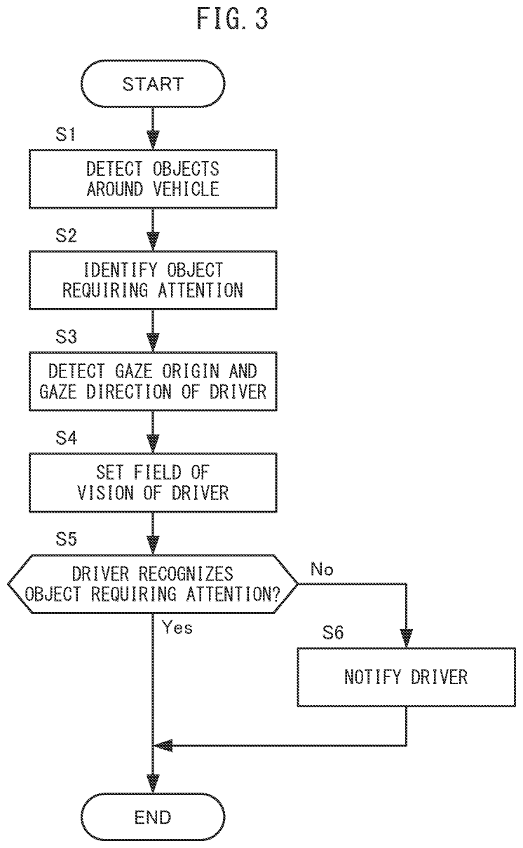

The processing part 43 has one or more CPUs (central processing units) and their peripheral circuits and runs various computer programs stored in the storage part 42, for example, is a processor. Below, referring to FIG. 3, one example of the processing performed at the processing part 43 and in turn the control device 4 will be example.

FIG. 3 is a flow chart for explaining details of processing for notification according to the present embodiment.

At step S1, the control device 4 detects objects present around the vehicle 100 based on surrounding data received from the surrounding sensor 1, specifically the surrounding images received from an external camera.

In the present embodiment, the control device 4 successively inputs surrounding images received from the external camera into a classifier and detects the regions in the surrounding images in which objects are shown and the types of the objects shown in those regions. The classifier, for example, can be made a convolutional neural network (CNN) having a plurality of convolution layers connected in series from the input side to the output side. Further, the control device 4 uses the standard sizes of the objects stored in the storage part 42 for each type of object and the size of an object detected at the surrounding images to estimate the distance from the external camera to the object and follows (tracks) the object detected at the surrounding images along a time series to calculate the position and speed of the object. Note that the method of detection of the object is not limited to such a method. Various known techniques may be used for detection.

At step S2, the control device 4 identifies an object to which attention should be paid (below, referred to as “object requiring attention”) from among the objects present around the vehicle 100. An object requiring attention can, for example, be another vehicle, a pedestrian, bicycle, or other object approaching the vehicle 100, that is, an object which may collide with the vehicle 100. However, the invention is not limited to this. For example, a pedestrian, bicycle, or other predetermined object decided on in advance may be identified as an object requiring attention. An object with a distance to the vehicle 100 smaller than a predetermined threshold value in a direction perpendicular to the advancing direction of the vehicle 100 (lateral direction) may also be identified as an object requiring attention.

At step S3, the control device 4 detects a gaze origin and gaze direction of the driver based on the driver data received from the driver sensor 2, specifically, the image of the appearance of the driver received from the driver monitor camera.

In the present embodiment, the control device 4 successively processes the facial images received from the driver monitor camera 21 to thereby detect the position of the center of a pupil forming a moving point (that is, the gaze origin of the driver) and the Purkinje image forming a reference point (corneal reflected image) and detects the gaze direction of the driver based on the positional relationship of the Purkinje image and center of the pupil (position of moving point with respect to reference point). Note that the method of detection of the gaze origin and gaze direction of the driver is not limited to such a method. Various known techniques may be used for detection.

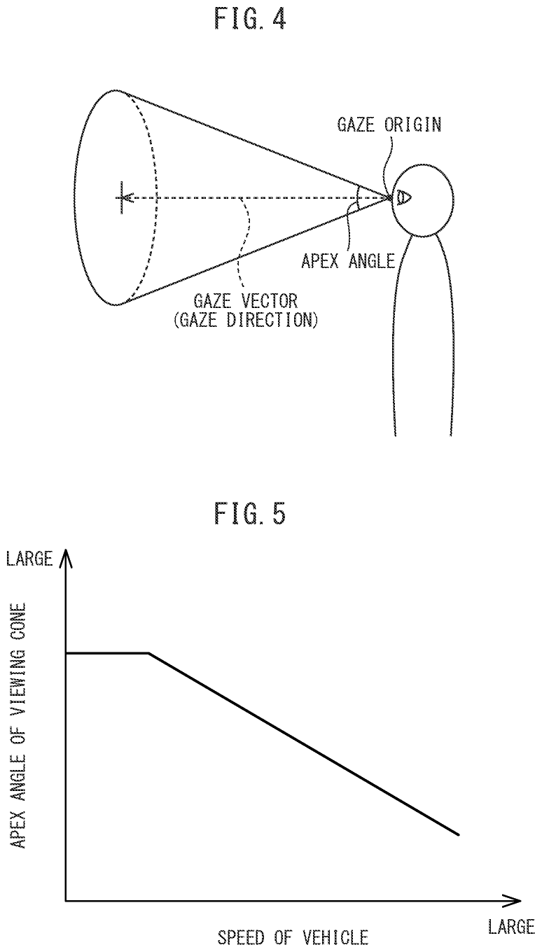

At step S4, the control device 4 sets the field of vision of the driver. As explained above, a field of vision of a driver tends to become narrower the higher a speed of a vehicle. Therefore, in the present embodiment, as shown in FIG. 4, a viewing cone having a gaze origin of the driver as its apex, having a gaze vector extending from the gaze origin toward the gaze direction as its center axis, and having a predetermined apex angle (angle of view) is assumed to be the field of vision of the driver, and the apex angle of the viewing cone is changed according to the speed of the vehicle. The apex of the field of vision does not necessarily have to be the gaze origin of the driver. For example, it may also be a center position of the face etc.

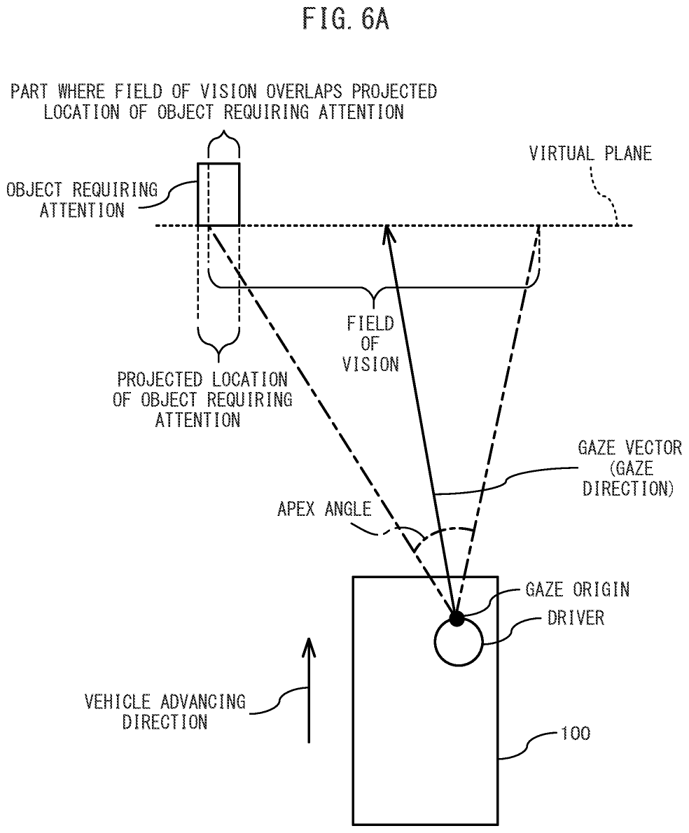

In the present embodiment, the control device 4 refers to a vision field setting line graph shown in FIG. 5 determined in advance by experiments etc. and sets the apex angle of the viewing cone based on the speed of the vehicle. As shown in FIG. 5, the apex angle of the viewing cone basically is made smaller when the speed of the vehicle is high compared to when it is low. Due to this, basically the higher the speed of the vehicle, the smaller the apex angle of the viewing cone and in turn the smaller a radius of the base of the viewing cone, so the narrower the field of vision of the driver can be made.

Note that, the shape of the vision field setting line graph shown in FIG. 5 is just one example. As shown in FIG. 5, the apex angle may also be made progressively smaller the higher the speed of the vehicle becomes. The invention is not limited to this. The apex angle may also be made smaller in stages the higher the speed of the vehicle becomes.

Further, in the present embodiment, as shown in FIG. 4, the shape of the field of vision was made a circular cone, but the shape of the field of vision is not limited to a circular cone and may also be an elliptical cone or polygonal cone or other cone. Further, the viewing cone shown in FIG. 4 was a so-called “right circular cone” with a center axis running through the center of gravity of the base, but it may also be a so-called “oblique circular cone” with a center axis not running through the center of gravity of the base.

Further, in the present embodiment, the apex angle of the viewing cone was set based on the speed of the vehicle, but the invention is not limited to this. It is also possible to judge the type of the road currently being run on (general road, highway, etc.) and set the apex angle of the viewing cone based on the type of the road. In this case, for example, it is sufficient to set the apex angle of the viewing cone to a predetermined value preset for each type of road in accordance with an average speed etc. of each type of road and sufficient to make the predetermined value smaller the higher the average speed of the road.

It is also possible to judge the shape of the road in the front direction (straight, curved, etc.) and set the apex angle of the viewing cone based on the shape of the road. In this case, the apex angle may be made larger than when it is a shape enabling running at a relatively high speed (for example, straight) if the shape of the road in the front direction is a shape requiring running at a relatively low speed (for example, a curve).

At step S5, the control device 4 judges whether the driver has recognized the object requiring attention. When the driver has recognized the object requiring attention, the control device 4 ends the current processing. On the other hand, when the driver has not recognized the object requiring attention, the control device 4 proceeds to the processing of step S6.

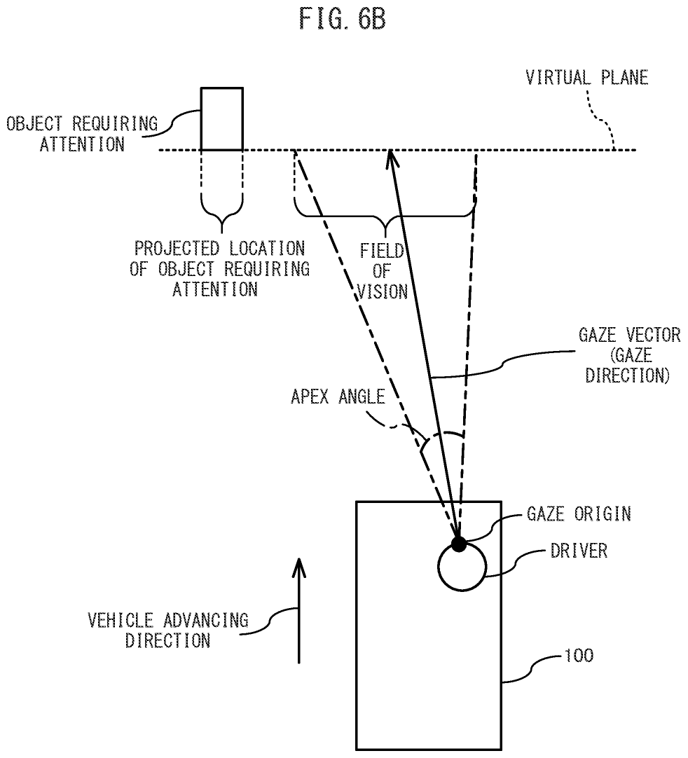

In the present embodiment, for example, as shown in FIG. 6A, the control device 4 sets a virtual plane on which the object requiring attention is projected so as to be perpendicular to the vehicle advancing direction. If the field of vision of the driver overlaps the projected location of the object requiring attention on the virtual plane, it judges that the driver has recognized the object requiring attention. On the other hand, as shown in FIG. 6B, if the field of vision of the driver does not overlap the projected location of the object requiring attention on the virtual plane, it judges that the driver has not recognized the object requiring attention. The speed of the vehicle in FIG. 6A is lower than the speed of the vehicle in FIG. 6B, therefore the field of vision in FIG. 6A is broader than the field of vision in FIG. 6B. Note that in FIG. 6A and FIG. 6B, the virtual plane is set to a position where the distance from the gaze origin of the driver to the object requiring attention becomes the shortest, but the invention is not limited to this. For example, it can also be set to a position at which the object requiring attention is included.

At step S6, the control device 4 initiates a safety measure for avoiding collision with the object requiring attention. In the present embodiment, as a safety measure, the driver is notified of the situation through the output device 3. The method of notification is not particularly limited. For example, notification may be performed by announcing by voice that an object requiring attention has not been recognized, notification may be performed by emitting a warning sound, notification may be issued by using graphic information or text information, or notification may be performed by a combination of the same.

Further, if the vehicle 100 is a vehicle in which at least part of the driving operations relating to acceleration, steering, and braking can be automatically performed (for example, a vehicle with an automated driving function or a vehicle with a driver's assistance function), as a safety measure, it is also possible to automatically perform the driving operations so as to avoid collision with the object requiring attention.

The control device 4 of a vehicle according to the present embodiment explained above is configured to detect an object requiring attention present around the vehicle to which attention should be paid based on surrounding data showing the situation around the vehicle, detect a gaze origin and gaze direction of the driver based on driver data showing the state of the driver, set a field of vision of the driver based on a speed of the vehicle, a type of road, or a shape of road, set a virtual plane on which the object requiring attention is projected at the position of the object requiring attention so as to face the vehicle, judge whether the field of vision of the driver overlaps the projected location of the object requiring attention on the virtual plane, and initiates a safety measure if the field of vision of the driver overlaps the projected location of the object requiring attention.

Specifically, the control device 4 is configured to set as the field of vision of the driver a cone having a gaze position of the driver as an apex, having a gaze vector extending from the gaze origin toward the gaze direction as a center axis, and having a predetermined apex angle and to change the apex angle based on a speed of the vehicle, type of road, or shape of road. The apex angle can, for example, be set to a smaller value when the speed of the vehicle is high compared to when it is low. Further, the apex angle can be set to a smaller value when the type of road is a road with a high average speed compared to when the type of road is a road with a low average speed. Further, the apex angle can for example be set to a smaller value when the shape of road is a shape enabling running at a relatively high speed compared to when the shape of road is a shape requiring running at a relatively low speed.

Due to this, it is possible to judge whether the driver has recognized an object requiring attention at the outside of the vehicle considering changes in the range of the field of vision of the driver, so it is possible to improve the precision of judgment of whether an object requiring attention has been recognized.

Further, the control device 4, as a safety measure, provides notification through an output device or performs driving operations of the vehicle automatically so as to avoid an object requiring attention, so it is possible to keep an object requiring attention from being collided with.

Above, embodiments of the present invention were explained, but the above embodiments only show some of the examples of application of the present invention. They are not intended to limit the technical scope of the present invention to the specific constitutions of the embodiments.

For example, the computer program run in the control device 4 in the above embodiments (processing for notification) may also be provided in a form recorded in a computer readable portable recording medium such as a semiconductor memory, magnetic recording medium, or optical recording medium.

1. A control device for a vehicle, wherein
the control device is configured to:
detect an object present around the vehicle to which attention should be paid based on surrounding data showing a situation around the vehicle;
detect a gaze direction of the driver based on driver data showing a state of a driver of the vehicle;
set a field of vision of the driver toward the gaze direction of the driver based on a speed of the vehicle, a type of road, or a shape of road;
set a virtual plane on which the object is projected at the position of the object so as to face the vehicle and judge whether a field of vision of the driver overlaps the projected location of the object; and
initiate a safety measure if the field of vision of the driver does not overlap the projected location of the object.

2. The control device for a vehicle according to claim 1, wherein
the control device is further configured to set as the field of vision of the driver a cone having a gaze origin of the driver as an apex, having a gaze vector extending from the gaze origin of the driver toward the gaze direction of the driver as a center axis, and having a predetermined apex angle and to change the apex angle based on the speed of the vehicle, type of road, or shape of road.

3. The control device for a vehicle according to claim 2, wherein
the control device is further configured to set the apex angle to a smaller value when the speed of the vehicle is high compared to when it is low.

4. The control device for a vehicle according to claim 2, wherein
the control device is further configured to set the apex angle to a smaller value when the type of the road is a road with a high average speed compared to when the type of the road is a road with a low average speed.

5. The control device for a vehicle according to claim 2, wherein
the control device is further configured to set the apex angle to a smaller value when the shape of the road is a shape enabling running by a relatively high speed compared to when the shape of the road is a shape where it is necessary to run at a relatively low speed.

6. The control device for a vehicle according to claim 1, wherein
the vehicle includes an output device configured to provide notification to the driver, and
the control device is configured to provide notification through the output device as the safety measure.

7. The control device for a vehicle according to claim 1, wherein
the control device is further configured to perform, as the safety measure, driving operations of the vehicle automatically so as to avoid an object.

8. A control method for a vehicle by a control device, wherein
the control method comprises:
detecting an object present around the vehicle to which attention should be paid based on surrounding data showing a situation around the vehicle;
detecting a gaze direction of the driver based on driver data showing a state of a driver of the vehicle;
setting a field of vision of the driver toward the gaze direction of the driver based on a speed of the vehicle, a type of road, or a shape of road;
setting a virtual plane on which the object is projected at the position of the object so as to face the vehicle and judging whether a field of vision of the driver overlaps the projected location of the object; and
initiating a safety measure if the field of vision of the driver does not overlap the projected location of the object.

9. A nontransitory computer recording medium including a computer program for a control device for a vehicle,
the nontransitory computer recording medium including a computer program making the control device:
detect an object present around the vehicle to which attention should be paid based on surrounding data showing a situation around the vehicle;
detect a gaze direction of the driver based on driver data showing a state of a driver of the vehicle;
set a field of vision of the driver toward the gaze direction of the driver based on a speed of the vehicle, a type of road, or a shape of road;
set a virtual plane on which the object is projected at the position of the object so as to face the vehicle and judge whether a field of vision of the driver overlaps the projected location of the object; and
initiate a safety measure if the field of vision of the driver does not overlap the projected location of the object.
